(19) United States
(12) Patent Application Publication
(10) Pub. No.: US 2013/0008886 A1
(43) Pub. Date: Jan. 10, 2013

(54) Glow plug

(76) Inventors: Christian POTTIEZ, Eppingen (DE); Yue CHENG, Shenyang (CN); Martin ALLGAIER, Ludwigsburg (DE); Bernd LAST, Reutlingen (DE)

(21) Appl. No.: 13/539,902

(22) Filed: Jul. 2, 2012

(30) Foreign Application Priority Data
Jul. 5, 2011 (DE) 10 2011 051 588.7
Oct. 14, 2011 (DE) 10 2011 054 511.1

(51) Int. Cl. H05B 3/02

(52) U.S. Cl. 219/538

(57) ABSTRACT

The invention relates to a glow plug comprising a glow pin, a housing from which the glow pin protrudes, and a supply line which runs in the housing and is connected to the glow pin so as to apply an electric voltage, and a sensor. According to the invention, it is provided that the supply line surrounds an interior in which a signal line connected to the sensor is arranged.

The invention is based on a glow plug with the features specified in the preamble of the claim 1. Such a glow plug is known, for example, from DE 10 2008 017 110 B3.

Glow plugs with sensors, for example pressure sensors, can provide important information about combustion parameters, in particular the combustion chamber pressure. The sensors of glow plugs are exposed to difficult operating conditions which complicate the measurements due to disturbing influences. Moreover, the space available in a glow plug housing is very limited. The construction of a glow plug with a sensor which enables meaningful measurements on combustion parameters such as the combustion chamber pressure or other parameters important for a glow plug control unit or engine control unit is therefore complicated and involves difficulties.

### SUMMARY OF THE INVENTION

It is an object of the invention to show a way on how the construction of a glow plug, the sensor of which enables meaningful measurements on combustion parameters such as the combustion chamber pressure or other parameters important for a glow plug control unit or engine control unit, can be improved.

In the case of a glow plug according to the invention, the supply line surrounds an interior in which a signal line connected to the sensor is arranged. Therefore, the spacing between housing and supply line of a glow plug according to the invention can be reduced with respect to a conventional glow plug in which the supply line is formed as a rod. As a result, the ohmic heat generated by the feed line can be better dissipated to the housing of the glow plug. Therefore, the thermal load of the sensor can be reduced. Another advantage is that the improved heat dissipation allows reducing the cross-sectional area of the supply line because a greater heat loss can be accepted. By a smaller cross-sectional area of the supply line, valuable installation space is gained in the housing of the glow plug, which space can be utilized for sensors, lines or circuit elements.

Moreover, in a glow plug according to the invention, the interior surrounded by the supply line is shielded from electric alternating fields. The effects of electromagnetic interferences on the signal line of the sensor running in said interior are therefore reduced in an advantageous manner. Preferably, the supply line surrounds a plurality of lines which are connected to the sensor.

In the case of a glow plug according to the invention, the sensor can be surrounded by the supply line. In this manner, the sensor can be shielded particularly well against interference signals. However, an improvement of the signal-to-noise ratio can be achieved already if the sensor is not surrounded by the supply line and only the signal line of the sensor is surrounded by the supply line.

The sensor of a glow plug according to the invention is preferably a pressure sensor. Instead of a pressure sensor or in addition to a pressure sensor, the glow plug can also comprise one or a plurality of other sensors, for example, a temperature sensor.

The signal line can be made, for example, from a wire. However, it is also possible to arrange the signal line and optionally further lines running to the sensor as a conductive layer or conductor path on an isolator, for example, a plastic film. For example, the isolator can be provided as a coating on the inner side of the supply line.

The supply line can be configured, for example, as a tube. In order to achieve a shielding of the signal line against electromagnetic interferences, the supply line can also be configured, for example, as a hose made of a metal mesh. It is also possible to configure the supply line as a coating on the inner side of the housing, for example as a wound-up film.

An advantageous refinement of the invention provides that the supply line and/or the housing are electrically isolated from each other by means of an isolation layer. Preferably, the isolation layer is configured as a coating of the supply line and/or the housing. In this manner, a good thermal coupling of the supply line to the housing can be achieved so that the supply line can be well cooled by the housing. The isolation layer is preferably made of plastic.

A further aspect of the invention relates to a glow plug comprising a glow pin, a housing from which said glow pin protrudes, a connecting element for applying a supply voltage to the glow pin, and a supply line running in the housing and electrically connecting the connecting element with glow pin, wherein the supply line is configured as a tube that extends in the housing over the major portion of the length of said housing. In the tube which forms the supply line, a signal line of a sensor can be arranged; however, the above-described advantages of an improved thermal coupling of the supply line to the housing can also be utilized for a glow plug without a sensor. Preferably, the tube in the housing has a length that is at least three quarters of the housing length.

### DETAILED DESCRIPTION OF THE DRAWINGS

Further details and advantages of the invention are illustrated by means of exemplary embodiments with reference to the attached drawings. Components that are identical and corresponding to each are provided with corresponding reference numbers. In the figures:

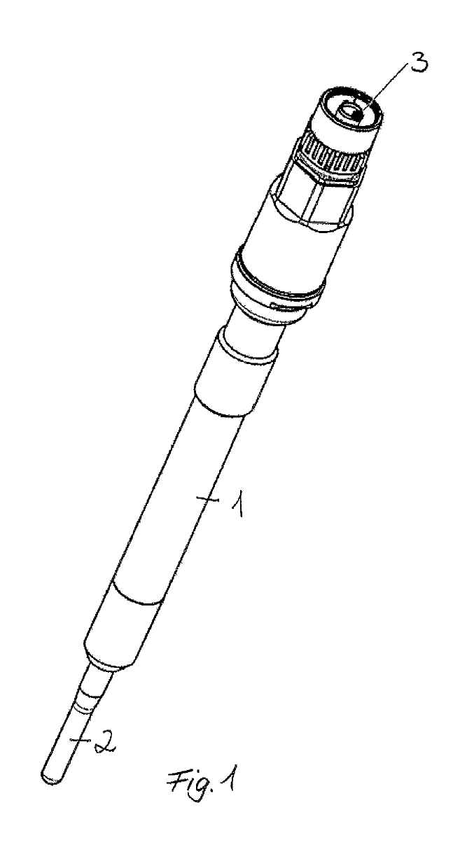

FIG. 1 shows an exemplary embodiment of a glow plug according to the invention;

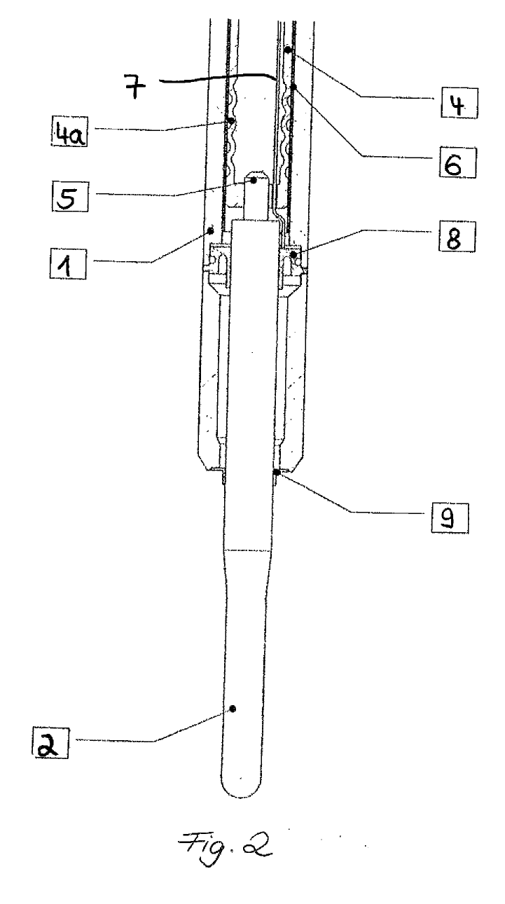

FIG. 2 shows a partial sectional view of FIG. 1;

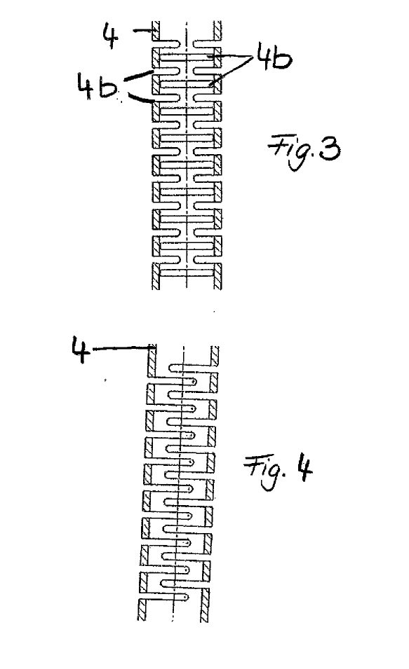

FIG. 3 shows an exemplary embodiment of the supply line;

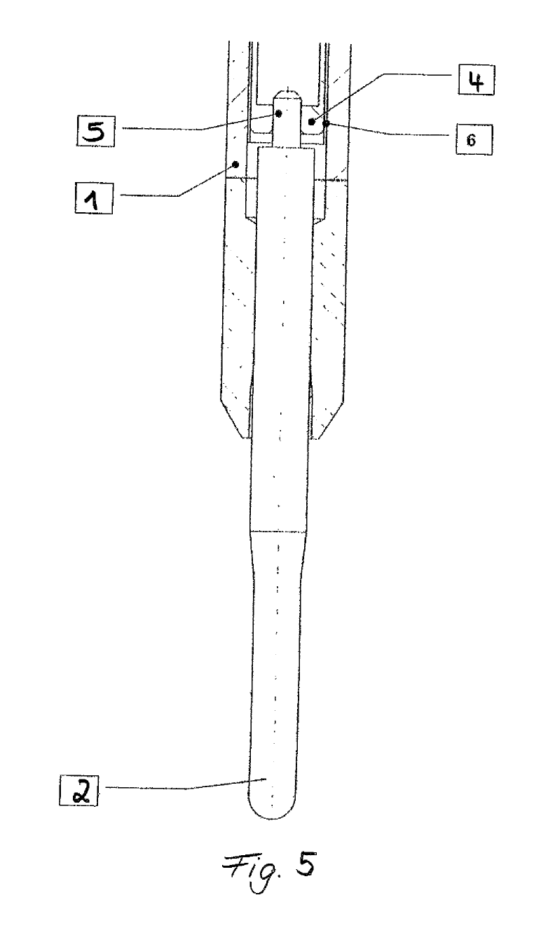

FIG. 4 shows a further exemplary embodiment of the supply line;

FIG. 5 shows a further exemplary embodiment of a glow plug; and

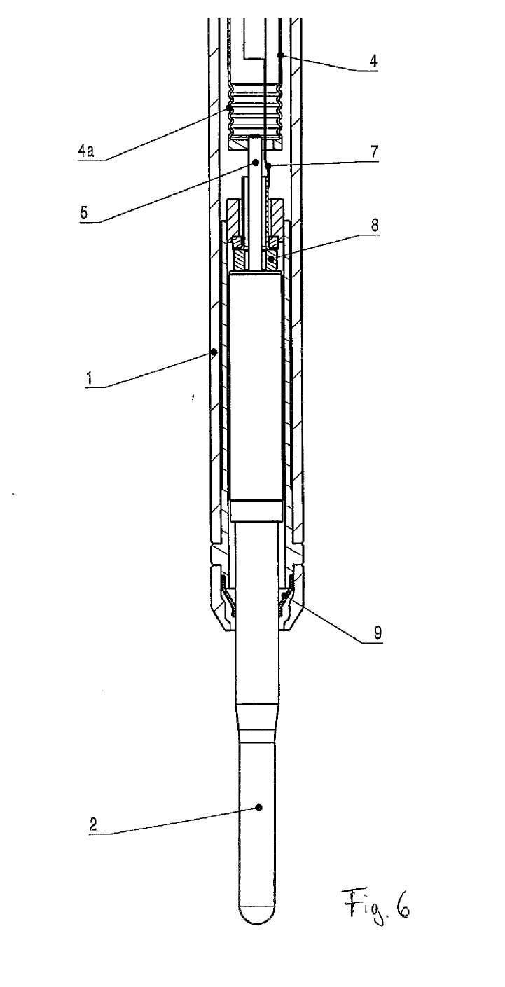

FIG. 6 shows a further exemplary embodiment of a glow plug.

### DETAILED DESCRIPTION

The glow plug illustrated in FIG. 1 has a housing 1, from the front end of which, a glow pin 2 protrudes. The glow plug can be a ceramic glow plug, thus can comprise a ceramic glow pin 2, or can be a steel glow plug and, for example, comprise a metallic helix which is arranged in a metal sleeve. At the rear end of the glow plug there is a potential connector 3 via which the glow pin 2 can be connected to a voltage source. The ground connection is carried out via the housing 1.

FIG. 2 shows a partial sectional view of the front part of the glow plug illustrated in FIG. 1. A supply line 4 via which the glow pin 2 is electrically connected to the connecting element 3 runs in the housing 1. The supply line 4 is connected at one end to the terminal 5 of the glow pin 2, and is connected at its other end to the connecting element 3. Another electrical terminal of the glow pin 2 is connected to the housing 1 in an electrically conductive manner.

The supply line 4 is formed as a tube. Between the supply line 4 and the housing 1, an isolation layer 6 is arranged. Said isolation layer 6 can be configured, for example, as a coating on the inner side of the housing 1. The supply line 4 touches this coating. Therefore a good thermal coupling to the housing 1 is formed. Ohmic heat generated in the supply line 4 thus can be efficiently dissipated to the housing 1.

The supply line 4 formed as a tube surrounds an interior. A signal line 7 leading to a pressure sensor 8 runs in this interior. Therefore, the signal line 7 is shielded by the supply line 4 against electromagnetic interferences. In addition to the signal line 7 illustrated in FIG. 2, further lines can be arranged in the interior surrounded by the supply line 4, in particular a second line running to the sensor 8.

In the illustrated embodiment, the signal line 7 is made from a wire, but can also be configured, for example, as a conductive layer in the supply line 4. For example, on the inner side of the supply line 4 there can be an isolation layer, for example made from plastic, which carries a conductive layer. In particular, the signal line can be arranged on a wound-up film which is arranged in the interior of the supply line 4.

In order to enable a measurement of the combustion chamber pressure, the glow pin 2 in the illustrated glow plug is arranged to be displaceable in the housing 1. With increasing combustion chamber pressure, the glow pin 2 is pushed slightly into the housing 1 against a reset force. With decreasing combustion chamber pressure, the reset force pushes the glow pin 2 out of the housing. These movements of the glow pin 2 can be detected with the pressure sensor 8 which is arranged outside of the supply line 4. Alternatively, it is also possible to use a pressure sensor which is arranged in the space surrounded by the supply line 4, for example a piezoelectric pressure sensor.

The interior of the housing 1 can be sealed with respect to combustion chamber by a diaphragm 9. Said diaphragm can be connected directly to the glow pin 2, for example by soldering, or can be secured on a protective sleeve which surrounds the glow pin. For example, the glow pin 2 can be pressed into a protective sleeve which is soldered or welded to the diaphragm. The diaphragm 9 can effect a sealing of the housing 1 and can also generate a reset force when the glow pin 2 is displaced in the longitudinal direction of the housing 1.

The glow pin 2 can be secured to the supply line 4 by soldering, welding, crimping or pressing, for example. Displacing the glow pin 2 results in a mechanical load acting on the supply line 4. In the illustrated exemplary embodiment, this load can be absorbed in that the supply line 4 is resiliently compressed in the longitudinal direction. The supply line 4 therefore has a corrugated section 4a, thus is a corrugated tube. The corrugated section 4a can be limited to a portion of the length of the supply line 4. However, it is also possible that the supply line 4 is corrugated over its entire length.

Resilient movability of the supply line 4 in its longitudinal direction can also be achieved in that the tube has slits running transverse to the longitudinal direction of said tube. Preferably, said slits run perpendicular to the longitudinal direction of the latter. Corresponding exemplary embodiments of a supply line 4 configured as a tube are illustrated in the FIGS. 3 and 4. The slits 4b are cut in different directions into the tube. In the exemplary embodiment illustrated in FIG. 3, the supply line 4 has 4 pairs of slits 4b which are opposing each other and point in opposite directions. Here, two types of pairs can be provided which are oriented differently, for example, oriented differently by 90°.

In the exemplary embodiment illustrated in FIG. 4, slits 4b in the supply line 4 are cut into the tube from opposing sides. The slits are arranged offset to each other and have in each case a depth which is more than half the diameter of the tube diameter.

FIG. 5 illustrates an example of a glow plug without a pressure sensor. Movability of the glow pin 2 relative to the housing 1 is not required for such glow plugs. Therefore, the glow pin 2 can be rigidly connected to the housing 1, for example, in that the glow pin 2 is pressed into the housing 1 or is soldered or welded to the housing 1. The glow pin 2 can be a ceramic glow pin or a metallic glow pin. As explained in connection with the exemplary embodiment of FIG. 2, the glow pin 2 can be held in a protective sleeve which is inserted in the housing 1.

In this exemplary embodiment too, the supply line 4 via which the glow pin 2 is electrically connected with the contact element 3 is configured as a tube. Resilient movability of the supply line 4 in its longitudinal direction is of minor importance in this exemplary embodiment. The slits 4b or corrugated sections 4a for increasing the movability are therefore not required. As in the exemplary embodiment of FIG. 2, the supply line 4 is electrically isolated with respect to the housing 1. The isolation layer 6 rests against the housing 1 and also against the supply line 4. In this manner, good thermal coupling is achieved.

The isolation layer 6 can be made from a ceramic material, or is preferably made of plastic, for example Kapton. By configuring the supply line 4 as a tube which extends in the housing 1 over the major portion of the length of the housing, lost heat of the supply line 4 can easily be dissipated to the housing 1. In particular by means of an isolation layer 6 made of plastic, electrical isolation can be combined with good thermal coupling.

The longer the supply line 4 configured as a tube, the better ohmic heat can be dissipated to the housing 1. In the illustrated exemplary embodiment, the supply line 4 therefore extends in the housing 1 over the major portion of the length of the latter. Preferably, the supply line 4 extends over at least 3/4 of the length of the housing 1. In particular, the supply line 4 can be secured directly to a terminal 5 of the glow pin 2 and/or directly to a terminal of the potential connector 3. For manufacturing-related reasons it can also be advantageous that the supply line 4 is secured at one or both ends to a connecting element which establishes a connection to the glow pin 2 or the potential connector 3. The length of such a connecting element should then be small relative to the length of the supply line 4 configured as a tube, for example less than ¼, in particular at least ⅕, preferred less than 1/10 of the length of the supply line 4.

FIG. 6 shows a further exemplary embodiment of a glow plug. As in the exemplary embodiment of FIG. 2, the supply line 4 is configured as a tube which has a corrugated section 4a, thus a section configured as a corrugated tube. In contrast to the exemplary embodiment of FIG. 2, an isolation layer 6, which electrically isolates the interior of the housing 1 from the supply line 4 where the housing surrounds the electric supply line, is eliminated. In the exemplary embodiment of FIG. 6, electrical isolation is achieved through sufficient spacing between the supply line 4 and the housing wall 1. Said spacing can be filled with a potting compound outing, a ceramic powder or other isolation materials. However, isolation can also be achieved without such isolation material simply by providing a sufficiently large spacing.

Another difference of the exemplary embodiment illustrated in FIG. 2 is the configuration of the pressure sensor 8 which, for example, can be configured as a piezoelectric sensor against which the glow pin 2 is pressed. Another possibility to configure a pressure sensor 8 is, for example, a diaphragm 8 which is secured to the glow pin 2 and which is deformed during an axial displacement of the glow pin 2.

### REFERENCE LIST

1 Housing
2 Glow pin
3 Potential connector
4 Supply line
4a Corrugated section
4b Slits
5 Terminal
6 Isolation layer
7 Signal line
8 Pressure sensor
9 Diaphragm

What is claimed is:

1. A glow plug comprising:
a glow pin;
a housing from which the glow pin protrudes;
a supply line running in the housing, said supply line being connected to the glow pin for applying an electric voltage;
a sensor wherein the supply line surrounds an interior; and
a signal line connected to the sensor arranged in said interior.

2. The glow plug according to claim 1, wherein the supply line is a tube.

3. The glow plug according to claim 2, wherein the supply line is a corrugated tube.

4. The glow plug according to claim 2 wherein the tube has slits running transverse to a longitudinal direction of said tube.

5. The glow plug according to claim 4, wherein the slits are cut in different directions into the tube.

6. The glow plug according to claim 4 wherein the glow plug has pairs of slits which oppose each other and run in opposite directions.

7. The glow plug according to claim 1 wherein the signal line is configured as a coating of the supply line.

8. The glow plug according to claim 7, wherein the signal line is arranged on a wound-up film which disposed in the supply line.

9. The glow plug according to claim 1 wherein the supply line and/or the housing are electrically isolated from each other by an isolation layer.

10. A glow plug comprising:
a glow pin;
a housing from which a the glow pin protrudes;
a connecting element for applying a supply voltage to the glow pin; and
a supply line running in the housing and connecting the connecting element with the glow pin, wherein the supply line is configured as a tube extending in the housing over a major portion of a length of said housing.
